(19) United States
(12) Patent Application Publication
(10) Pub. No.: US 2016/0121449 A1
(43) Pub. Date: May 5, 2016

(54) PNEUMATIC GRINDING TOOL

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: WEI CAO, Shenzhen (CN)

(21) Appl. No.: 14/716,450

(22) Filed: May 19, 2015

(30) Foreign Application Priority Data
Oct. 29, 2014 (CN) 201410590260.9

(51) Int. Cl. B24B 23/02; B25F 5/00

(52) U.S. Cl. CPC B24B 23/026; B25F 5/001

(57) ABSTRACT

A pneumatic grinding tool includes a rotatable shaft, a rotor, a sleeve, a bearing assembly, a fixing member, and an air feed assembly. The rotatable shaft includes a rotatable main body, a first connecting portion, a second connecting portion, and a clamping portion for clamping a grinding head. The bearing assembly is positioned between the sleeve and the rotatable shaft. The fixing member is connected to the second connecting portion. The air feed assembly includes a main body, an air inlet, and an air outlet. One end of the main body is sleeved on the sleeve, and the rotor is received in the main body. The main body, the sleeve, the bearing assembly and the rotatable shaft cooperatively form an air chamber configured such that when air flows into the air chamber, and the vanes of the rotor rotate, the rotatable shaft rotates with the rotor.

### FIELD

The subject matter herein generally relates to a pneumatic grinding tool.

### BACKGROUND

Pneumatic grinding tools are widely used in the field of machining A pneumatic grinding tool is pen-shaped and configured to draw on a workpiece or grind the workpiece, and the workpiece can be made of metal, glass, plastic, porcelain and other materials.

### BRIEF DESCRIPTION OF THE DRAWINGS

Implementations of the present technology will now be described, by way of example only, with reference to the attached figures.

FIG. 1 is an isometric view of an embodiment of a pneumatic grinding tool.

FIG. 2 is an exploded, isometric view of the pneumatic grinding tool shown in FIG. 1.

FIG. 3 is an exploded, isometric view of the pneumatic grinding tool shown in FIG. 1 viewed from another angle.

FIG. 4 is a cross-sectional view of the pneumatic grinding tool taken along a line IV-IV shown in FIG. 1.

FIG. 5 is a cross-sectional view of the pneumatic grinding tool taken along a line V-V shown in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is relation to a pneumatic grinding tool.

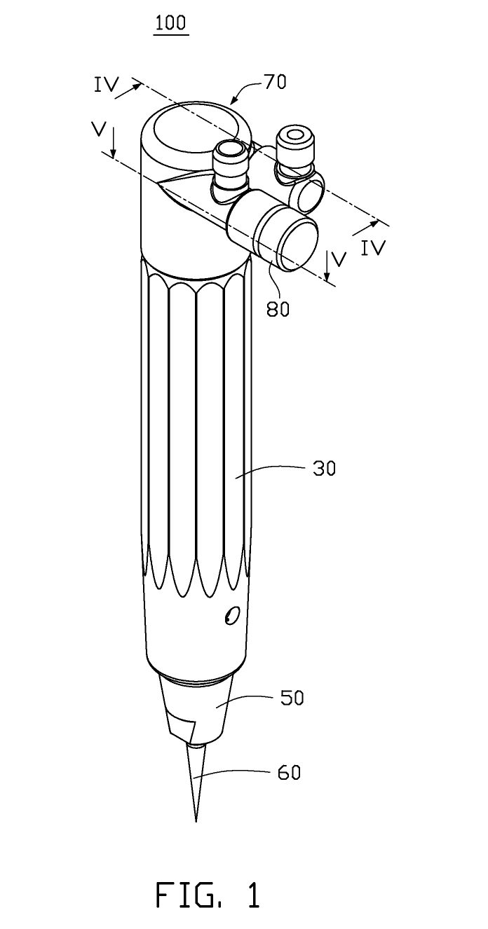

FIG. 1 illustrates that a pneumatic grinding tool 100 can include a sleeve 30, a fixing member 50, a grinding head 60, an air feed assembly 70, and a speed governing assembly 80. The grinding head 60 can be coupled to the fixing member 50, and the speed governing assembly 80 can be coupled to the air feed assembly 70.

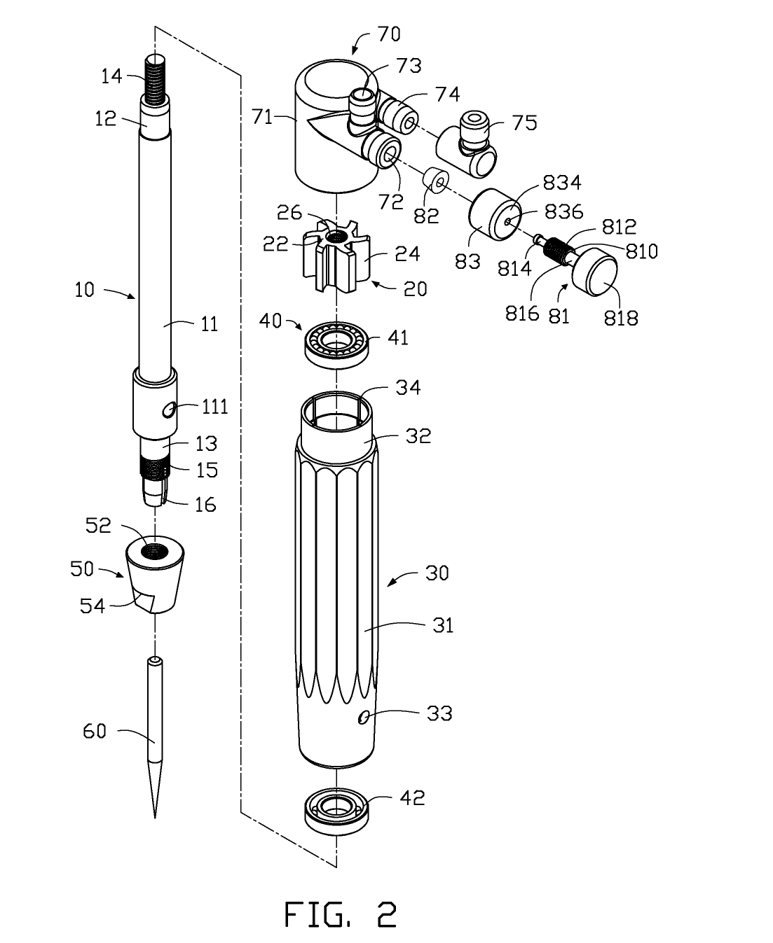

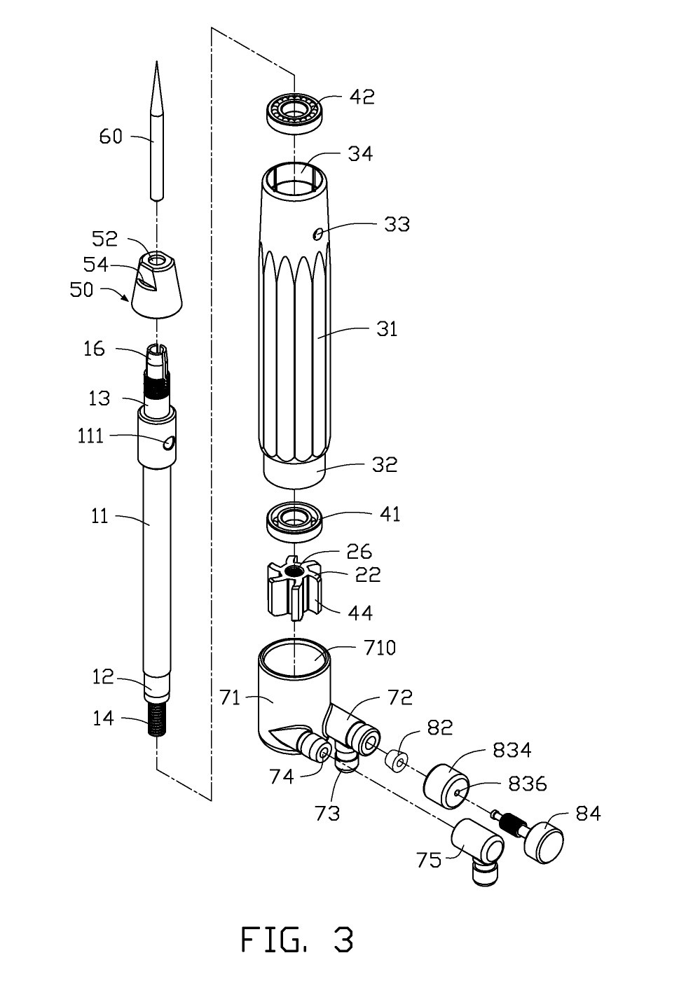

FIG. 2 and FIG. 3 illustrate that the pneumatic grinding tool 100 can further include a rotatable shaft 10, a rotor 20, and a bearing assembly 40.

The rotatable shaft 10 can include a rotatable main body 11, a first fixing portion 12, a second fixing portion 13, a first connecting portion 14, a second connecting portion 15, and a clamping portion 16. The first fixing portion 12 and the second fixing portion 13 can be positioned at two opposing ends of the rotatable main body 11. The first connecting portion 14 can be positioned at one side of the first fixing portion 12 away from the rotatable main body 11, and the second connecting portion 15 can be positioned at one side of the second fixing portion 13 away from the rotatable main body 11. The clamping portion 16 can be positioned one side of the second connecting portion 15 away from the rotatable main body 11. The rotatable main body 11 can be column-shaped and define a first detaching hole 111 through a circumference surface thereof. The clamping portion 16 can be used to clamp the grinding head 60. In at least one embodiment, the clamping portion 16 can have three clamping jaws.

The rotor 20 can be threaded onto the first connecting portion 14 and include a connecting portion 22 and a plurality of vanes 24 surrounding the connecting portion 22. The connecting portion 22 can define a first threaded hole 26. The rotor 20 can be threaded onto the first connecting portion 14 by the first threaded hole 26.

The sleeve 30 can be sleeved on the rotatable shaft 10 and include a sleeve main body 31, a third fixing portion 32 positioned at one end of the sleeve main body 31, a second detaching hole 33 corresponding to the first detaching hole 111, and one or more heat radiating grooves 34. The heat radiating groove 34 can be defined in an inner wall of the sleeve main body 31 along the length, and can be in communication with the second detaching hole 33.

The bearing assembly 40 can include a first bearing 41 and a second bearing 42. An inner ring of the first bearing 41 can be sleeved on the first fixing portion 12, and an outer ring of the first bearing 41 can abut one end of the inner wall of the sleeve main body 31 adjacent to the third connecting portion 32. An inner ring of the second bearing 42 can be sleeved on the second fixing portion 13, and an outer ring of the second bearing 42 can abut the other end of the inner wall of the sleeve main body 31.

The fixing member 50 can be taper-shaped and define a threaded hole 52 and a mounting groove 54. A diameter of the threaded hole 52 can be slightly larger than a diameter of the grinding head 60, thus the grinding head 60 can pass through the threaded hole 52. The mounting groove 54 can be defined at an outer wall of the fixing member 50. When the fixing member 50 is threaded onto the second connecting portion 15 by the threaded hole 52, the clamping portion 16 and one end of the grinding head 60 clamped by the clamping member 16 can be received in the threaded hole 52, and the clamping jaws of the clamping member 16 can be restricted by the threaded hole 52. Therefore, the grinding head 60 can be fixed by the fixing member 50 and connected to the rotatable shaft 10. When the rotor 20 rotates, the rotatable shaft 10 can rotate with the rotor 20, and the grinding head 60 can rotate with the rotatable shaft 10.

The air feed assembly 70 can include a main body 71, a speed governing port 72, an air inlet 73, an air outlet 74, and an adapter 75. The main body 71 can be hollow column-shaped, and one end of the main body 71 can be closed. The speed governing port 72 can protrude out of the side wall of the main body 71. The air inlet 73 can be in communication with and substantially perpendicular to the air outlet 74. One end of the main body 71 with an opening can be sleeved on the third fixing portion 32.

The speed governing assembly 80 can include a control valve 81, a rubber plug 82, and a sealing member 83. The control valve 81 can include a control rod 810, an external thread 812 arranged on the control rod 810, a first engaging portion 814, a second engaging portion 816, and a holding portion 818. The first engaging portion 814 and the second engaging portion 816 can be positioned at two opposing ends of the control rod 810, and the holding portion 818 can be positioned at one side of the second engaging portion 816 distal from the control rod 810. The sealing member 83 can be cap-shaped and include an receiving groove 832 therein. The sealing member 83 can define a through hole 836 at a bottom 834 of the receiving groove 832. The sealing member 83 can be mounted to the second engaging portion 816 and sleeved on the speed governing port 72.

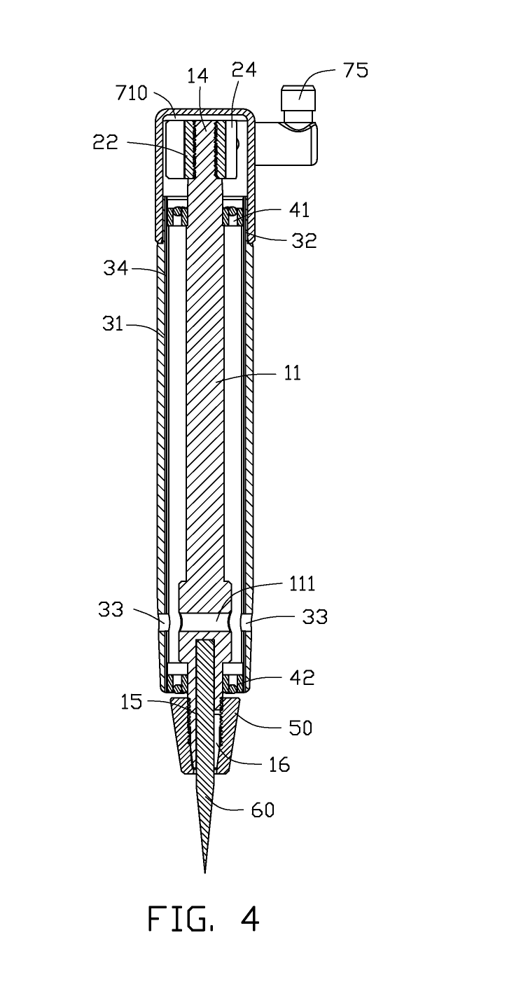

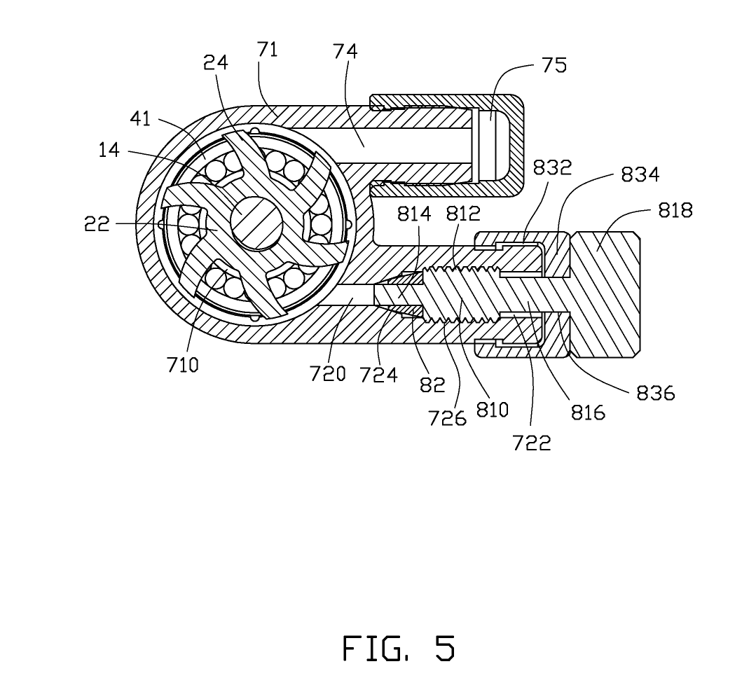

FIG. 4 illustrates that the main body 71, the third fixing portion 32, the first bearing 41, and the first fixing portion 12 can cooperatively form an air chamber 710. The speed governing assembly 80 can be configured for governing air flowing from the air inlet 73 to the air chamber 710. FIG. 5 illustrates that the speed governing port 72 can define a first hole 720, a second hole 722, and a tapered hole 724 connecting the first hole 720 and the second hole 722. A diameter of the first hole 720 can be smaller than a diameter of the second hole 722. The first hole 720 can be in communication with the air chamber 710, and the second hole 722 can be in communication with the first hole 720 through the tapered hole 724. The second hole 722 can include an internal thread 726. Referring to FIG. 3 through FIG. 5, the air chamber 710 can be in communication with the air inlet 73 and the air outlet 74. The air inlet 73 can be connected to an external air source (not shown). The air outlet 74 can be connected to a flexible pipe (not shown) through the adapter 75 to exclude the air in the air chamber 710 and reduce noise.

When the control valve 81 is mounted in the speed governing port 72, the external thread 812 of the control valve 81 can be engaged with the internal thread 726 of the second hole 722. The rubber plug 82 can be taper shaped and have high elasticity. An inner diameter of the rubber plug 82 can match with an inner diameter of the first engaging portion 814, and the rubber plug 82 can be sleeved on the first engaging portion 814. An outer diameter of the rubber plug 82 can be larger than the tapered hole 724, thus the rubber plug 82 can seal the tapered hole 724. When the sealing member 83 is mounted on the second engaging portion 816 and sleeved on the speed governing port 72, one end portion of the speed governing port 72 is received in the receiving groove 832, and the two ends of the bottom 834 of the sealing member 83 abut speed governing port 72 and the holding portion 818, thus the speed governing port 72 can be sealed. The control valve 81 can be rotated and move toward the air chamber 710, thus the air flowing from the air inlet 73 to the air chamber 710 can be decreased. On the contrary, the control valve 81 can be rotated and move away from the air chamber 710, thus the air flowing from the air inlet 73 to the air chamber 710 can be increased.

In assembly, the first bearing 41 can be mounted to the first fixing portion 12, the second bearing 42 can be mounted to the second fixing portion 13, and the sleeve 30 can be sleeved on the first bearing 41 and the second bearing 42. The grinding heard 60 can be coupled to the clamping portion 16 of the rotatable shaft 10, and the fixing member 50 can be mounted to the second connecting portion 15. The rotor 20 can be mounted to the first connecting portion 14, and the air feed assembly 70 can be mounted to the third mounting portion 32, thus the rotor 20 can be received in the air feed assembly 70. The rubber plug 82 can be inserted into the tapered hole 724 of the air feed assembly 70, and the sealing member 83 can be sleeved on the second engaging portion 816 of the control valve 82. The control valve 82 can be inserted into the second hole 722. One end of an air inlet pipe can be coupled to the air inlet 73, and the other end of the air inlet pipe can be coupled to the external air source. The air outlet 74 can be coupled to the flexible pipe through the adapter 75.

In operation, the air can flow into the air chamber 710 through the air inlet 73, and the rotor 20 can rotate driven by the air. The rotatable shaft 10 and the grinding heard 60 can rotate with the rotor 20. The distance between the control valve 82 and the air chamber 710 can be adjusted, thus the gas flow flowing into the air chamber 710 can be controlled, and the rotating speed of the rotor 20 can be controlled. The heat generated in operation can be guided to the first detaching hole 111 and the second detaching hole 33 through the heat radiating groove 34, thus the heat can be dissipated. In detaching, a tool can be inserted into the first detaching hole 111 and the second detaching hole 33, thus the rotatable shaft 10 and the sleeve 30 would not move relative to each other, and other elements of the pneumatic grinding tool 100 can be detached by applying a force. In other embodiments, the mounting groove 54 can abut a workpiece, thus the other elements of the pneumatic grinding tool 100 can be detached by applying a force.

The rotor can rotate driven by the air, and the rotatable shaft and the grinding head can rotate with the rotor. As the distance between the control valve and the air chamber can be controlled, the rotating speed of the grinding head can be controlled. The flexible pipe connected to the air outlet can reduce the noise. The heat can be dissipated through the heat radiating groove and the detaching holes. The pneumatic grinding tool can be simple, easy to keep, lower noise, and less heat.

In other embodiments, the bearing assembly 40 can include one or more bearings.

In other embodiments, the first fixing portion 12 and the second fixing portion 13 can be omitted, and the bearing assembly 40 can be sleeved on the rotatable main body 11.

In other embodiments, the speed governing port 72 and the air inlet 73 can form a certain angle.

In other embodiments, the rubber plug 82 and/or the sealing member 83 can be omitted, as long as the control valve 82 is well sealed.

In other embodiments, the speed governing assembly 80 and the speed governing port 72 can be omitted if there is no need of controlling the speed.

The embodiments shown and described above are only examples. Many details are often found in the art such as the other features of pneumatic grinding tool. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, comprising in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A pneumatic grinding tool comprising:
a rotatable shaft comprising a rotatable main body, a first connecting portion and a second connecting portion arranged at two opposing sides of the rotatable main body, and a clamping portion arranged at one side of the second connecting portion away from the rotatable main body, the clamping portion configured to clamp a grinding head;
a rotor connected to the first connecting portion and comprising a plurality of vanes;
a sleeve sleeved on the rotatableshaft;
a bearing assembly positioned between the sleeve and the rotatable shaft;
a fixing member connected to the second connecting portion to mount the grinding head; and
an air feed assembly comprising a main body, an air inlet and an air outlet protruding from the main body, the air inlet being configured to couple to an external air source;
wherein one end of the main body is sleeved at one end of the sleeve adjacent to the first connecting portion, and the rotor is received in the main body; and
wherein the main body, the sleeve, the bearing assembly and the rotatable shaft cooperatively form an air chamber configured such that when air flows into the air chamber through the air inlet, and the vanes of the rotor rotate, the rotatable shaft rotates with the rotor.

2. The pneumatic grinding tool as claimed in claim 1,
wherein the rotatable shaft further comprises a first fixing portion and a second fixing portion arranged at two opposing ends of the rotatable main body;
wherein the first connecting portion is arranged at one side of the first connecting portion away from the rotatable main body, and the second connecting portion is arranged at one side of the second fixing portion away from the rotatable main body; and
wherein the clamping portion is positioned at one side of the second connecting portion away from the rotatable main body.

3. The pneumatic grinding tool as claimed in claim 2,
wherein the bearing assembly comprises a first bearing and a second bearing, an inner ring of the first bearing is sleeved on the first fixing portion, and an outer ring of the first bearing abuts an inner wall of the sleeve; and
wherein an inner ring of the second bearing is sleeved on the second fixing portion, and an outer ring of the second bearing abuts the inner wall of the sleeve.

4. The pneumatic grinding tool as claimed in claim 1,
wherein the fixing member defines a threaded hole, and the grinding head passes through the threaded hole; and
wherein the fixing member further comprises a mounting groove.

5. The pneumatic grinding tool as claimed in claim 1, wherein the rotatable main body defines a first detaching hole through a circumference surface thereof, and the sleeve comprises a sleeve main body and a second detaching hole corresponding to the first detaching hole.

6. The pneumatic grinding tool as claimed in claim 5, wherein the sleeve further comprises a heat radiating groove defined in an inner wall of the sleeve main body along the length, and the heat radiating groove is in communication with the second detaching hole.

7. The pneumatic grinding tool as claimed in claim 5, wherein the sleeve further comprises a third fixing portion positioned at one end of the sleeve main body, one end of the main body of the air feed assembly is sleeved on the third fixing portion, and the rotor is received in the main body.

8. The pneumatic grinding tool as claimed in claim 1,
wherein the main body of air feed assembly further comprises a speed governing port in communication to the air inlet, the pneumatic grinding tool further comprises a speed governing assembly, and the governing assembly comprises a control valve;
wherein the control valve is mounted into the speed governing port to control the air flowing into the air chamber; and
when the control valve is rotated to move toward the air chamber, the air flowing to the air chamber is decreased; and
when the control valve is rotated to move away from the air chamber, the air flowing to the air chamber is increased.

9. The pneumatic grinding tool as claimed in claim 8,
wherein the control valve comprises a control rod and a first engaging portion positioned at one side of the control rod, the speed governing assembly further comprises a rubber plug sleeve on the first engaging portion;
wherein the speed governing port defines a first hole, a second hole, and a tapered hole connecting the first hole and the second hole, the first hole is communication to the air chamber, and the second hole is in communication to the first hole through the tapered hole; and
wherein the rubber plug is sleeved on the first engaging portion and pressed into the tapered hole for sealing.

10. The pneumatic grinding tool as claimed in claim 9,
wherein the control valve comprises a second engaging portion positioned at the other side of the control rod and a holding portion positioned at the second engaging portion away from the control rod;
wherein the speed governing assembly further comprises a sealing member, and the sealing member defines a receiving groove and a through hole at a bottom of the receiving groove;
wherein the sealing member is sleeved on the second engaging portion by the through hole;
when the sealing member is sleeved on the second engaging portion and the speed governing port, one end portion of the speed governing port is received in the receiving groove, one end of the bottom of the sealing member abuts the speed governing port, and the other end of the bottom abuts the holding portion.

11. The pneumatic grinding tool as claimed in claim 9, wherein the second hole comprises an internal thread, and the control valve comprises an external thread engaged with the internal thread of the second hole.
